(19) United States
(12) Patent Application Publication
(10) Pub. No.: US 2012/0172272 A1
(43) Pub. Date: Jul. 5, 2012

(54) CLEANING COMPOSITION FOR SEMICONDUCTOR DEVICE AND METHOD OF CLEANING SEMICONDUCTOR DEVICE USING THE SAME

(76) Inventors: Yong Yeop PARK, Uiwang-si (KR); Jung Min CHOI, Uiwang-si (KR); Go Un KIM, Uiwang-si (KR); Kang Su AN, Uiwang-si (KR)

(21) Appl. No.: 13/339,437

(22) Filed: Dec. 29, 2011

(30) Foreign Application Priority Data
Dec. 31, 2010 (KR) 10-2010-0140034
Dec. 23, 2011 (KR) 10-2011-0141792

(51) Int. Cl. C11D 7/60

(52) U.S. Cl. 510/175

(57) ABSTRACT

A cleaning composition for a semiconductor device and a method of cleaning a semiconductor device, the composition including about 0.001 to about 0.5 wt % of a fluorine compound, based on a total weight of the composition; about 0.1 to about 10 wt % of an alkyl, aryl, or aralkyl-substituted ammonium hydroxide compound, based on a total weight of the composition; about 0.1 to about 10 wt % of a nitrogen-containing carboxylic acid, based on a total weight of the composition; about 0.01 to about 1 wt % of a water-soluble polymer compound, based on a total weight of the composition; and water.

### BACKGROUND

1. Field

Embodiments relate to a cleaning composition for a semiconductor device and a method of cleaning a semiconductor device using the same.

2. Description of the Related Art

After various processes for manufacturing a semiconductor device, e.g., dry etching or ion implantation, a photoresist pattern (used as a mask) may be removed or eliminated. In addition, when a photoresist pattern is misaligned, it may be removed in order to form a new photoresist pattern.

Completely removing photoresist residues and etching residues from a substrate without damaging a lower layer (which may include copper and/or aluminum) is desirable. A photoresist removal process may be carried out by a combination of dry stripping (including ashing) and wet stripping (using an organic stripper). Wet stripping removes photoresist residues, which may not be completely removed by the dry stripping (such as ashing), and impurities (including etching residues formed in an etching process for forming various patterns, such as single-layer or multilayer patterns including tungsten, aluminum, copper, titanium, or titanium nitride, or formed in an etching process or ashing process for forming contact holes or via holes to expose the wiring patterns).

Etching by-products to be removed may include organic polymers (formed by reaction of C, H, and O elements of photoresist patterns and wiring materials with plasma in a plasma etching process or reactive ion etching (RIE)), organo-metallic polymers (formed by back-sputtering of wiring materials on side walls of photoresist patterns and contact holes or via holes in etching or ashing), and insulating material or metallic oxides (formed by back-sputtering of an insulating layer under a wiring pattern due to over-etching).

### SUMMARY

Embodiments are directed to a cleaning composition for a semiconductor device and a method of cleaning a semiconductor device using the same.

The embodiments may be realized by providing a cleaning composition for a semiconductor device, the composition including about 0.001 to about 0.5 wt % of a fluorine compound, based on a total weight of the composition; about 0.1 to about 10 wt % of an alkyl, aryl, or aralkyl-substituted ammonium hydroxide compound, based on a total weight of the composition; about 0.1 to about 10 wt % of a nitrogen-containing carboxylic acid, based on a total weight of the composition; about 0.01 to about 1 wt % of a water-soluble polymer compound, based on a total weight of the composition; and water.

The nitrogen-containing carboxylic acid may include at least one selected from the group of iminodiacetic acid, proline, hydroxyproline, 1-pyrroline-5-carboxylic acid, N-acetylglutamic acid, cilastatin, and folic acid.

The fluorine compound may include at least one selected from the group of hydrofluoric acid (HF), ammonium fluoride (NH₄F), ammonium bifluoride (NH₄F.HF), tetramethylammonium fluoride (N(CH₃)₄F), fluoroboric acid (HBF₄), and fluorobenzene (C₆H₅F).

The alkyl, aryl, or aralkyl-substituted ammonium hydroxide compound may include an ammonium hydroxide compound containing a substituted ammonium ion in which at least one substituent selected from the group of a C1 to C20 alkyl group, a C6 to C20 aryl group, and a C7 to C20 aralkyl group is bonded to nitrogen of the ammonium ion.

The alkyl, aryl, or aralkyl-substituted ammonium hydroxide compound may include at least one selected from the group of tetramethylammonium hydroxide, tetraethylammonium hydroxide, tetrapropylammonium hydroxide, tetraoctylammonium hydroxide, benzyltriethylammonium hydroxide, diethyldimethylammonium hydroxide, hexadecyltrimethylammonium hydroxide, and methyltributylammonium hydroxide.

The water-soluble polymer compound may include at least one selected from the group of polyvinyl alcohol, polyethylene glycol, polyethyleneimine, and poly(meth)acrylic acid.

The cleaning composition may have a pH of about 3.0 to about 6.0.

The cleaning composition may further include at least one selected from the group of catechol, gallic acid, pyrogallol, 4-methyl catechol fumaric acid, and diethylhydroxylamine.

The cleaning composition may be used to clean a semiconductor device including at least one kind of wire selected from the group of copper and aluminum wires.

The embodiments may also be realized by providing a method of cleaning a semiconductor device, the method including cleaning a semiconductor substrate having an etched film using the cleaning composition according to an embodiment.

Cleaning the semiconductor substrate may be conducted at about 20 to about 40° C.

Cleaning the semiconductor substrate may be conducted for about 20 to about 60 seconds.

### DETAILED DESCRIPTION

Korean Patent Application No. 10-2010-0140034, filed on Dec. 31, 2010, and Korean Patent Application No. 10-2011-0141792, filed on Dec. 23, 2011, in the Korean Intellectual Property Office, and entitled: “Cleaning Composition for Semiconductor Device and Cleaning Method of Semiconductor Device Using the Same” is incorporated by reference herein in its entirety.

Example embodiments will now be described more fully hereinafter; however, they may be embodied in different forms and should not be construed as limited to the embodiments set forth herein. Rather, these embodiments are provided so that this disclosure will be thorough and complete, and will fully convey the scope of the invention to those skilled in the art.

It will be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present.

An embodiment provides a cleaning composition for effectively removing photoresist residues or etching residues that remain on various thin films or semiconductor substrates after forming the thin films (e.g., various metal layers or insulating layers) on the semiconductor substrate and patterning (etching) using photoresist.

The cleaning composition may help effectively remove photoresist residues or etching residues, may help control contamination of a semiconductor substrate using an anticorrosive agent, and may help reduce damage to various thin films of a semiconductor device in a cleaning process.

The cleaning composition for a semiconductor device according to an embodiment may include about 0.001 to about 0.5 wt % of a fluorine compound, based on a total amount of the composition, about 0.1 to about 10 wt % of an alkyl, aryl, or aralkyl-substituted ammonium hydroxide compound, based on a total amount of the composition, about 0.1 to about 10 wt % of a nitrogen-containing carboxylic acid, based on a total amount of the composition, about 0.01 to about 1 wt % of a water-soluble polymer compound, based on a total weight of the composition, and water. In an implementation a remaining amount of the composition, e.g., a balance of the composition, may be water.

Fluorine Compound

The fluorine compound may dissolve silicon oxide components to generate silicon fluoride (that is a salt of hydrosilicohydrofluoric acid), thereby facilitating etching. In etching, oxidative polymer residues, polymer residues on a lateral wall, various photoresist residues or etching residues including organic metal compounds or metal oxides, which remain on a lateral wall or a lower side of a thin film after ashing, may be removed. The organic metal compounds or metal oxides may include at least one selected from the group of copper, copper alloys, titanium, titanium nitride, tantalum, tantalum nitride, tungsten, alloys of titanium and tungsten, aluminum, and aluminum alloys, without being limited thereto.

The fluorine compound may include at least one selected from the group of hydrofluoric acid (HF), ammonium fluoride (NH₄F), ammonium bifluoride (NH₄F.HF), tetramethylammonium fluoride (N(CH₃)₄F), fluoroboric acid (HBF₄), and fluorobenzene (C₆H₅F), without being limited thereto.

The fluorine compound may be selected depending on a kind of photoresist residues or etching residues. For example, the fluorine compound may include hydrofluoric acid or mixtures including hydrofluoric acid in order to help in the removal of oxidative polymer residues. The fluorine compound may include ammonium fluoride or mixtures including ammonium fluoride in order to help in the removal of organic metal compounds or metal oxides.

The fluorine compound may be present in the cleaning composition in an amount of about 0.001 to about 0.5 wt %. Maintaining the amount of the fluorine compound at about 0.001 wt % or greater may help ensure that photoresist residues or etching residues are effectively removed. Maintaining the amount of the fluorine compound at about 0.5 wt % or less may help ensure that excessive amounts of the fluorine compound are not present, thereby preventing corrosion or damage to various thin films or patterns thereof on a semiconductor substrate. In an implementation, the amount of the fluorine compound may be about 0.01 to about 0.5 wt %.

Alkyl, aryl, or aralkyl-substituted ammonium hydroxide compound

The alkyl, aryl, or aralkyl-substituted ammonium hydroxide compound may help in the removal of oxidative polymer residues, various photoresist residues, or etching residues (including organic metal compounds or metal oxides) along with the fluorine compound. Further, the alkyl, aryl, or aralkyl-substituted ammonium hydroxide compound may help control adhesion of particles or metal ions dispersed in the cleaning composition to a surface of a semiconductor substrate. Further, the compound may help control contamination of particles or metals due to re-adhesion of the particles or metal ions.

The alkyl, aryl, or aralkyl-substituted ammonium hydroxide compound may be a compound containing a substituted ammonium ion in which at least one substituent selected from the group of a C1 to C20 alkyl group, a C6 to C20 aryl group, and a C7 to C20 aralkyl group is bonded to nitrogen (instead of hydrogen) of an ammonium ion (NH₄⁺). For example, 1 to 4 substituents may be bonded thereto. In an implementation, the substituent may be at least one selected from the group of a C1 to C16 alkyl group and a C7 to C10 aralkyl group.

The alkyl, aryl, or aralkyl-substituted ammonium hydroxide compound may include at least one selected from the group of tetramethylammonium hydroxide, tetraethylammonium hydroxide, tetrapropylammonium hydroxide, tetraoctylammonium hydroxide, benzyltriethylammonium hydroxide, diethyldimethylammonium hydroxide, hexadecyltrimethylammonium hydroxide, and methyltributylammonium hydroxide, without being limited thereto.

In an implementation, tetramethylammonium hydroxide or mixtures including the same may be used as the alkyl, aryl, or aralkyl-substituted ammonium hydroxide compound. Tetramethylammonium hydroxide may help effectively remove or eliminate various organic residues or oxides and may help suitably control contamination of particles or metals.

The alkyl, aryl, or aralkyl-substituted ammonium hydroxide compound may be present in the cleaning composition in an amount of about 0.1 to about 10 wt %. Maintaining the amount of the alkyl, aryl, or aralkyl-substituted ammonium hydroxide compound at about 0.1 wt % or greater may help ensure that various photoresist residues or etching residues are effectively removed. Maintaining the amount of the alkyl, aryl, or aralkyl-substituted ammonium hydroxide compound at about 10 wt % or less may help prevent various thin films or patterns thereof on a semiconductor substrate from being corroded or damaged. In an implementation, the amount of the alkyl, aryl, or aralkyl-substituted ammonium hydroxide compound may be about 0.3 to about 10 wt %.

Nitrogen-Containing Carboxylic Acid

The nitrogen-containing carboxylic acid may help in the removal of residues, such as organic metal compounds or metal oxides.

In addition, the nitrogen-containing carboxylic acid may serve to adjust a pH of the cleaning composition to a range of about 3.0 to about 6.0. As the nitrogen-containing carboxylic acid suitably adjusts the pH of the cleaning composition, an excessive increase in the included amount of fluorine compound may be controlled, thereby minimizing damage or corrosion of various thin films or patterns thereof on a semiconductor substrate.

In addition, the nitrogen-containing carboxylic acid may not cause damage to copper wiring (as compared with a carboxylic acid that only includes carbon, oxygen, and hydrogen) and may have excellent ability of removing etching residues, such as organo-metallic polymers and metal oxides.

The nitrogen-containing carboxylic acid may include any suitable monocarboxylic acid or dicarboxylic acid that has acidity in an aqueous solution and is capable of adjusting the pH of the cleaning composition. For example, the nitrogen-containing carboxylic acid may include an iminodiacetic acid, proline, hydroxyproline, 1-pyrroline-5-carboxylic acid, N-acetylglutamic acid, cilastatin, folic acid or a mixture thereof, without being limited thereto.

In an implementation, iminodiacetic acid or mixtures including iminodiacetic acid may be used as the nitrogen-containing carboxylic acid. Iminodiacetic acid may adjust the pH of the cleaning composition to a proper range and have help in the removal of metal oxides.

The nitrogen-containing carboxylic acid may be present in a suitable amount depending on a desired pH range of the cleaning composition. For example, the nitrogen-containing carboxylic acid may be present in the cleaning composition in an amount of about 0.1 to about 10 wt %, based on a total weight of the composition. Within this range, the cleaning composition may have a suitably adjusted pH range, thereby effectively removing various organic metal compounds or metal oxides while reducing and/or preventing damage to various thin films or patterns thereof (e.g., metal patterns or oxide layer patterns) on a semiconductor substrate. In an implementation, the nitrogen-containing carboxylic acid may be included in an amount of about 0.5 to about 10 wt %.

Water-Soluble Polymer Compound

The water-soluble polymer compound may help prevent corrosion of a metal film. A typical anticorrosive agent may remain on a surface of metal after completion of a washing process, thereby causing contamination of a semiconductor substrate. However, the water-soluble polymer compound may be easily rinsed in a cleaning process after washing and thus little to none may remain, thereby minimizing contamination of a semiconductor substrate.

The water-soluble polymer compound may include at least one selected from the group of polyvinyl alcohol, polyethylene glycol, polyethyleneimine, and poly(meth)acrylic acid, without being limited thereto. Different kinds of water-soluble polymer compounds may be used depending on kinds of formed metal films.

The water-soluble polymer compound may be present in the composition in an amount of about 0.01 to about 1 wt %. Maintaining the amount of the water-soluble polymer compound at about 0.01 wt % or greater may help effectively prevent or control corrosion of a metal film. Maintaining the amount of the water-soluble polymer compound at about 1 wt % or less may help ensure that the water-soluble polymer compound is not excessively present, thereby ensuring removal or elimination of various photoresist residues or etching residues on a semiconductor substrate. In an implementation, the water-soluble polymer compound may be present in an amount of about 0.02 to about 0.5 wt %.

The cleaning composition may further include a remaining, e.g., balance, amount of water. In the cleaning composition, the above components may be dissolved in water and may be used to clean a semiconductor substrate or various structures on the semiconductor substrate.

The cleaning composition may have a pH of about 3.0 to about 6.0. Within this range, various organic metal compounds and metal oxides may be effectively removed. In an implementation, the cleaning composition may have a pH of about 3.2 to about 5.8.

The pH may be adjusted depending on the amounts of the fluorine compound, the alkyl, aryl, or aralkyl-substituted ammonium hydroxide compound, the nitrogen-containing carboxylic acid, and/or the water-soluble polymer compound, particularly the amount of the nitrogen-containing carboxylic acid.

The cleaning composition may further include an additive, which may contribute to removal or elimination of organic or oxidative photoresist residues or etching residues. For example, the cleaning composition may further include, as an anticorrosive agent, at least one selected from the group of catechol, gallic acid, pyrogallol, 4-methyl catechol fumaric acid, diethylhydroxylamine, and mixtures thereof.

The cleaning composition may be provided per se. Also, the cleaning composition may be concentrated to remove whole or part of the remaining water of the cleaning composition to make a concentrate. The concentrate may be mixed with water to provide the cleaning composition.

The cleaning composition according to an embodiment may be used as a cleaning composition for a semiconductor device that includes a wire formed of copper and/or aluminum.

Another embodiment provides a method of cleaning a semiconductor device. The method may include cleaning a semiconductor substrate (on which an etched film is formed) with the cleaning composition according to an embodiment.

In an embodiment, the method of cleaning the semiconductor device may include forming a patternable film on a semiconductor substrate; forming a photoresist pattern on the patternable film; etching the patternable film using the photoresist pattern as a mask to form an etched film; and cleaning the semiconductor substrate (having the etched film thereon) with the cleaning composition.

Forming the patternable film, forming the photoresist pattern, and etching may be carried out by any suitable method known in the art.

The cleaning composition for a semiconductor device is described in detail above.

For example, a patternable film (e.g., various thin films including a metal film or an insulating layer) and a photoresist pattern may be sequentially formed on a semiconductor substrate. The patternable film may include various thin films formed on the semiconductor substrate, e.g., metal films including an aluminum film and a copper film, oxide films, or insulating layers. Then, the patternable film may be etched using the photoresist pattern as a mask to form an etched film, and the semiconductor substrate (including the etched film thereon) may then be cleaned using the cleaning composition. Accordingly, photoresist residues or etching residues (which may be generated while etching the patternable film and may remain on the semiconductor substrate or the etched film) may be effectively removed using the cleaning composition.

In the method of cleaning the semiconductor device, the cleaning composition may be provided to the semiconductor substrate in a single-type cleaning apparatus, thereby cleaning the semiconductor substrate.

In cleaning with the cleaning composition, a cleaning temperature is not particularly limited. In an implementation, the cleaning temperature may be about 20° C. to about 40° C. Maintaining the temperature at about 20° C. or higher may help ensure that photoresist residues or etching residues are effectively removed and a copper oxide film is sufficiently removed or eliminated. Maintaining the temperature at about 40° C. or less may help ensure that a copper oxide film, photoresist residues, or etching residues are suitably removed without substantially etching aluminum and/or copper, thereby helping to reduce and/or prevent considerable damage to various thin films or patterns on the semiconductor substrate.

In cleaning with the cleaning composition, a cleaning time is not particularly limited. In an implementation, the cleaning time may be about 20 to about 60 seconds. Maintaining the cleaning time at about 20 seconds or greater may help ensure sufficient exposure time to the cleaning composition, thereby ensuring that photoresist residues or etching residues are suitably removed. Maintaining the cleaning time at about 60 seconds or less may help ensure that photoresist residues or etching residues are effectively removed, while preventing substantial etching of aluminum and/or copper, thereby helping to reduce and/or prevent damage to thin films or patterns on the semiconductor substrate.

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

### Example 1

Based on a total amount of a cleaning composition, 0.01 wt % of hydrofluoric acid, 0.3 wt % of tetramethylammonium hydroxide, 0.5 wt % of iminodiacetic acid, 0.02 wt % of polyethyleneimine, and a remaining amount of water were mixed to form the cleaning composition. The cleaning composition had a pH of 5.8.

### Example 2

Based on a total amount of cleaning composition, 0.01 wt % of hydrofluoric acid, 0.75 wt % of tetramethylammonium hydroxide, 1 wt % of iminodiacetic acid, 0.05 wt % of polyethyleneimine, and a remaining amount of water were mixed to form the cleaning composition. The cleaning composition had a pH of 4.2.

### Example 3

Based on a total amount of cleaning composition, 0.1 wt % of hydrofluoric acid, 2.5 wt % of tetramethylammonium hydroxide, 3.5 wt % of iminodiacetic acid, 0.05 wt % of polyethyleneimine, and a remaining amount of water were mixed to form the cleaning composition. The cleaning composition had a pH of 3.8.

### Example 4

Based on a total amount of cleaning composition, 0.02 wt % of hydrofluoric acid, wt % of tetramethylammonium hydroxide, 7 wt % of iminodiacetic acid, 0.5 wt % of polyethyleneimine, and a remaining amount of water were mixed to form the cleaning composition. The cleaning composition had a pH of 4.0.

### Example 5

Based on a total amount of cleaning composition, 0.5 wt % of hydrofluoric acid, wt % of tetramethylammonium hydroxide, 10 wt % of iminodiacetic acid, 0.1 wt % of polyethyleneimine, and a remaining amount of water were mixed to form the cleaning composition. The cleaning composition had a pH of 5.8.

### Example 6

Based on a total amount of cleaning composition, 0.2 wt % of hydrofluoric acid, 2.0 wt % of tetramethylammonium hydroxide, 3.0 wt % of proline, 0.1 wt % of polyethyleneimine, and a remaining amount of water were mixed to form the cleaning composition. The cleaning composition had a pH of 4.1.

### Example 7

Based on a total amount of a cleaning composition, 0.4 wt % of hydrofluoric acid, 2.5 wt % of tetramethylammonium hydroxide, 5 wt % of hydroxyproline, 0.05 wt % of polyethyleneimine, and a remaining amount of water were mixed to form the cleaning composition. The cleaning composition had a pH of 3.2.

### Example 8

Based on a total amount of a cleaning composition, 0.02 wt % of hydrofluoric acid, 1.5 wt % of tetramethylammonium hydroxide, 3.5 wt % of 1-pyrroline-5-carboxylic acid, 0.2 wt % of polyethyleneimine, and a remaining amount of water were mixed to form the cleaning composition. The cleaning composition had a pH of 5.2.

### Comparative Example 1

A cleaning composition was prepared in the same manner as in Example 4 except that oxalic acid was used instead of iminodiacetic acid. The cleaning composition had a pH of 5.2.

### Comparative Example 2

A cleaning composition was prepared in the same manner as in Example 4 except that malonic acid was used instead of iminodiacetic acid. The cleaning composition had a pH of 5.6.

### Comparative Example 3

A cleaning composition was prepared in the same manner as in Example 1 except that iminodiacetic acid was not used. The cleaning composition had a pH of 10.2.

### Comparative Example 4

A cleaning composition was prepared in the same manner as in Example 1 except that 12.5 wt % of iminodiacetic acid was used. The cleaning composition had a pH of 2.1.

### Comparative Example 5

A cleaning composition was prepared in the same manner as in Example 1 except that 0.05 wt % of iminodiacetic acid was used. The cleaning composition had a pH of 9.5.

### Comparative Example 6

A cleaning composition was prepared in the same manner as in Example 1 except that polyethyleneimine was not included. The cleaning composition had a pH of 2.5.

### Comparative Example 7

A cleaning composition was prepared in the same manner as in Example 3 except that iminodiacetic acid was not included, and 3 wt % of acetic acid was further added. The cleaning composition had a pH of 4.5.

### Comparative Example 8

A cleaning composition was prepared in the same manner as in Example 3 except that tetramethylammonium hydroxide was not included, and 4 wt % of aqueous ammonia was further added. The cleaning composition had a pH of 4.4.

### Experimental Example 1

### Evaluation of Cleaning Compositions

The cleaning compositions according to Examples 1 to 8 and Comparative Examples 1 to 8 were evaluated as follows.

1. Etched Amount of Aluminum

A titanium/titanium nitride film was deposited on a silicon substrate, and an aluminum film was deposited to a thickness of 3,000 Å thereon to form samples. The aluminum film of each sample was dipped into respective cleaning compositions for 30 minutes, followed by measuring a thickness of the aluminum film using a thickness measuring device to evaluate an etched amount of aluminum. Results are shown in Table 1, below.

2. Etched Amount of Copper

A tantalum/tantalum nitride film was deposited on a silicon substrate, and a copper film was deposited to a thickness of 5,000 Å thereon. The copper film of each sample was dipped into respective cleaning compositions for 30 minutes, followed by measuring a thickness of the copper film using a thickness measuring device to evaluate an etched amount of copper. Results are shown in Table 1.

3. Ability of Cleaning Composition to Remove Copper Oxide Film

To evaluate whether the cleaning compositions remove a copper oxide film, a multilayer film (in which a 2 cm×2 cm silicon oxide film, a barrier film (TaN), and a copper film were sequentially deposited) was formed. The multilayer film of each sample was dipped into a hydrogen peroxide solution for 3 hours to form a copper oxide film, followed by spinning with respective cleaning compositions. The cleaning compositions had a temperature of 25° C. Subsequently, the samples were spun with deionized water for 2 minutes to remove the cleaning compositions from the test samples.

Then, nitrogen gas (N₂) was introduced to a top of the samples to completely dry the samples. The samples were observed using a scanning electron microscope S-5000 (Hitachi) to evaluate an extent to which the copper oxide film on the surface of each sample was removed.

As a result of observation, each cleaning composition was determined to have the ability to remove the copper oxide film. That is, as the copper oxide film was removed in a shorter time, each cleaning composition had a greater ability to remove the copper oxide film.

Cleaning ability of each cleaning composition was evaluated based on two important aspects as follows. First, whether the cleaning compositions quickly infiltrated a photoresist pattern and rapidly separated the photoresist pattern from the substrate. Second, whether the substrate (having the photoresist pattern removed) did not have impurities remaining on the surface after rinsing and drying.

From these aspects, ability of the cleaning compositions prepared in Examples 1 to 8 and Comparative Examples 1 to 8 to clean photoresist patterns and etching residues was evaluated as follows.

⊚: Copper oxide film was removed within 10 seconds (excellent removal rate).

∘: Copper oxide film was removed within 1 minute (within removal rate limit).

Δ: Copper oxide film was removed within 3 minutes (exceeding removal rate limit).

x: Copper oxide film was not removed within 3 minutes.

4. Ability of Cleaning Composition to Remove Photoresist Residues or Etching Residues

To evaluate whether the cleaning compositions removed photoresist residues or etching residues, a multilayer film (in which a silicon oxide film, a first barrier film (Ti/TiN), an aluminum film, and a second barrier film were sequentially deposited on a 2 cm×2 cm silicon substrate) was formed. A photoresist pattern was formed on the multilayer film, and the multilayer film exposed through the photoresist pattern was etched, thereby forming a multilayer film pattern exposing the first barrier film. Then, the photoresist pattern was sequentially subjected to ashing to prepare samples to evaluate whether the photoresist residues or etching residues were removed.

The samples were spun with respective cleaning compositions for 30 seconds. The cleaning compositions had a temperature of 25° C. Subsequently, the samples were spun with deionized water for 2 minutes to remove the cleaning compositions from the test samples. Then, nitrogen gas (N₂) was introduced to a top of the samples to completely dry the samples. The samples were observed using a scanning electron microscope S-5000 (Hitachi) to evaluate a degree of removal of photoresist residues or etching residues of the multilayer film pattern included in each sample. Results are shown in Table 1.

⊚: Photoresist residues or etching residues were completely removed.

∘: Photoresist residues or etching residues remained within 10 wt % of initial amount.

Δ: Photoresist residues or etching residues remained exceeding 10 wt % of initial amount.

x: Photoresist residues or etching residues were not removed at all.

TABLE 1

| | | | | | Removal | |
|---|---|---|---|---|---|---|
| | | | | Removal | of | |
| | | Etched | Etched | of | photoresist | |
| | | amount of | amount of | copper | residues or | |
| | | aluminum | copper | oxide | etching | |
| Example | | (Å/min) | (Å/min) | film | residues | pH |
| Example | 1 | 10 | 2.5 | ◯ | ◯ | 5.8 |
| | 2 | 10 | 5 | ⊚ | ◯ | 4.2 |
| | 3 | 15 | 5 | ⊚ | ⊚ | 3.8 |
| | 4 | 20 | 5 | ⊚ | ⊚ | 4.0 |
| | 5 | 23 | 10 | ⊚ | ⊚ | 5.8 |
| | 6 | 15 | 2.5 | ⊚ | ◯ | 4.1 |
| | 7 | 20 | 7.5 | ⊚ | ⊚ | 3.2 |
| | 8 | 15 | 5 | ◯ | ⊚ | 5.2 |
| Comparative | 1 | 20 | 5 | X | Δ | 5.2 |
| Example | 2 | 20 | 5 | X | Δ | 5.6 |
| | 3 | 10 | 30 | X | Δ | 10.2 |
| | 4 | 30 | 50 | ⊚ | ◯ | 2.1 |
| | 5 | 10 | 10 | Δ | Δ | 9.5 |
| | 6 | 20 | 50 | ⊚ | ◯ | 2.5 |
| | 7 | 20 | 10 | Δ | Δ | 4.5 |
| | 8 | 20 | 120 | ◯ | ◯ | 4.4 |

As shown in Table 1, the cleaning compositions according to Examples 1 to 8 removed the copper oxide film within 1 minute (without causing damage to the aluminum and copper films) and removed most of various photoresist residues or etching residues.

However, in Comparative Examples 1 and 2, the cleaning compositions (respectively having oxalic acid and malonic acid) had a considerably reduced rate of removing the copper oxide film and photoresist residues or etching residues. Further, the cleaning composition that did not contain iminodiacetic acid (according to Comparative Example 3), exhibited reduced performance in removing the copper oxide film as well as a high pH, and thus showed remarkably decreased performance in removing photoresist residues or etching residues, as compared with the cleaning composition according to Example 1.

According to Comparative Example 4, the cleaning composition having a pH lower than 3.0 had low anti-corrosion effects from the water-soluble polymer compound and caused severe damage to the aluminum and copper films. The cleaning composition having a pH higher than 6.0 (according to Comparative Example 5), exhibited a decrease not only in the rate of removing the copper oxide film, but also in performance of removing photoresist residues or etching residues. Thus, it may be seen that high pH controlled effects of the fluorine compound and dicarboxylic acid.

The cleaning composition containing no water-soluble polymer compound (according to Comparative Example 6) did not include an anticorrosive agent and substantially etched the aluminum and copper films, thereby causing remarkable damage to various thin films or patterns thereof on a semiconductor substrate.

The cleaning composition including an acetic acid instead of an iminodiacetic acid (according to Comparative Example 7) exhibited a low rate of removing the copper oxide film and thus it was difficult to apply the cleaning composition to the process.

Further, the cleaning composition using aqueous ammonia instead of an alkylammonium hydroxide compound (according to Comparative Example 8) substantially etched the copper oxide film, thereby causing remarkable damage to various thin films or patterns thereof on a semiconductor substrate.

### Experimental Example 2

### Evaluation of Use Conditions of Cleaning Composition

A semiconductor device was cleaned with the cleaning composition according to Example 1 while changing conditions of use of the cleaning composition. Then, an etched amount of aluminum, an etched amount of copper, performance of removing the copper oxide film, and performance of removing the photoresist residues or etching residues were evaluated. The results are shown in Table 2, below. In Table 2, the symbols represent the same results as described with respect to Table 1.

TABLE 2

| | Etched | Etched | Removal | Removal of photo- |
|---|---|---|---|---|
| | amount of | amount of | of copper | resist residues |
| | aluminum | copper | oxide | or etching |
| Conditions | (Å/min) | (Å/min) | film | residues |
| 20° C./30 sec | 8 | 2.2 | ◯ | ◯ |
| 30° C./30 sec | 11 | 3.5 | ⊚ | ⊚ |
| 40° C./30 sec | 20 | 8.5 | ⊚ | ⊚ |
| 25° C./20 sec | — | — | ◯ | ◯ |
| 25° C./60 sec | — | — | ⊚ | ⊚ |
| 15° C./30 sec | 5 | 1.6 | Δ | Δ |
| 45° C./30 sec | 35 | 20 | ⊚ | ⊚ |
| 25° C./10 sec | — | — | — | Δ |
| 25° C./90 sec | 35 | 30 | — | ⊚ |

As shown in Table 2, when cleaning was conducted at 20° C. to 40° C. for 20 to 60 seconds, the copper oxide film was removed within 1 minute without any damage to the aluminum and copper films and various photoresist residues or etching residues were mostly or completely removed.

However, it may be seen that when the cleaning composition was used at a temperature lower than 20° C., photoresist residues or etching residues were not sufficiently removed, and performance of removing the copper oxide film decreased. At a temperature higher than 40° C., excellent performance of removing not only the copper oxide film but also photoresist residues or etching residues was obtained, but aluminum and copper were increasingly etched, thereby causing considerable damage to various thin films or patterns thereof on a semiconductor substrate.

Further, when cleaning with the cleaning composition was conducted for less than 20 seconds, an exposure time to the cleaning composition was insufficient, and thus photoresist residues or etching residues were not sufficiently removed. When cleaning was conducted for longer than 60 seconds, excellent performance of removing photoresist residues or etching residues was obtained, but aluminum and copper were increasingly etched, causing considerable damage to various thin films or patterns thereof on a semiconductor substrate.

By way of summation and review, cleaning compositions for removal of photoresist residues or etching residues may be suitable to clean aluminum wiring but may cause corrosion of copper wiring. Some cleaning compositions may employ a corrosion inhibitor in order to prevent corrosion of copper wiring, which may undesirably occur during a cleaning process. However, some corrosion inhibitors may interact with etching residues to suppress dissolution of residues in a cleaning composition, thereby adversely affecting the cleaning process. Further, some additives may remain on a surface of copper after completion of the cleaning process, resulting in contamination of a semiconductor substrate. A contaminated semiconductor substrate may increase electric resistance, thereby reducing reliability of a semiconductor device or process yield.

The embodiments provide a composition that effectively removes photoresist residues or etching residues without corrosion of metal wiring, e.g., copper and aluminum, and includes an anticorrosive agent that may be easily rinsed off.

The embodiments provide a cleaning composition for a semiconductor device, which includes a nitrogen-containing carboxylic acid, e.g., an iminodiacetic acid, to effectively remove photoresist residues or etching residues from an etched or patterned film.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A cleaning composition for a semiconductor device, the composition comprising:
about 0.001 to about 0.5 wt % of a fluorine compound, based on a total weight of the composition;
about 0.1 to about 10 wt % of an alkyl, aryl, or aralkyl-substituted ammonium hydroxide compound, based on a total weight of the composition;
about 0.1 to about 10 wt % of a nitrogen-containing carboxylic acid, based on a total weight of the composition;
about 0.01 to about 1 wt % of a water-soluble polymer compound, based on a total weight of the composition; and
water.

2. The cleaning composition as claimed in claim 1, wherein the nitrogen-containing carboxylic acid includes at least one selected from the group of iminodiacetic acid, proline, hydroxyproline, 1-pyrroline-5-carboxylic acid, N-acetylglutamic acid, cilastatin, and folic acid.

3. The cleaning composition as claimed in claim 1, wherein the fluorine compound includes at least one selected from the group of hydrofluoric acid (HF), ammonium fluoride (NH₄F), ammonium bifluoride (NH₄F.HF), tetramethylammonium fluoride (N(CH₃)₄F), fluoroboric acid (HBF₄), and fluorobenzene (C₆H₅F).

4. The cleaning composition as claimed in claim 1, wherein the alkyl, aryl, or aralkyl-substituted ammonium hydroxide compound includes an ammonium hydroxide compound containing a substituted ammonium ion in which at least one substituent selected from the group of a C1 to C20 alkyl group, a C6 to C20 aryl group, and a C7 to C20 aralkyl group is bonded to nitrogen of the ammonium ion.

5. The cleaning composition as claimed in claim 1, wherein the alkyl, aryl, or aralkyl-substituted ammonium hydroxide compound includes at least one selected from the group of tetramethylammonium hydroxide, tetraethylammonium hydroxide, tetrapropylammonium hydroxide, tetraoctylammonium hydroxide, benzyltriethylammonium hydroxide, diethyldimethylammonium hydroxide, hexadecyltrimethylammonium hydroxide, and methyltributylammonium hydroxide.

6. The cleaning composition as claimed in claim 1, wherein the water-soluble polymer compound includes at least one selected from the group of polyvinyl alcohol, polyethylene glycol, polyethyleneimine, and poly(meth)acrylic acid.

7. The cleaning composition as claimed in claim 1, wherein the cleaning composition has a pH of about 3.0 to about 6.0.

8. The cleaning composition as claimed in claim 1, further comprising at least one selected from the group of catechol, gallic acid, pyrogallol, 4-methyl catechol fumaric acid, and diethylhydroxylamine.

9. The cleaning composition as claimed in claim 1, wherein the cleaning composition is used to clean a semiconductor device including at least one kind of wire selected from the group of copper and aluminum wires.

10. A method of cleaning a semiconductor device, the method comprising cleaning a semiconductor substrate having an etched film using the cleaning composition as claimed in claim 1.

11. The method as claimed in claim 10, wherein cleaning the semiconductor substrate is conducted at about 20 to about 40° C.

12. The method as claimed in claim 10, wherein cleaning the semiconductor substrate is conducted for about 20 to about 60 seconds.
